(19) United States
(12) Patent Application Publication
(10) Pub. No.: US 2012/0084225 A1
(43) Pub. Date: Apr. 5, 2012

(54) Automated system for ordering taxicab services and controlling operation of taxicabs

(76) Inventor: Dmitry Soldatenkov, Togliatti (RU)

(21) Appl. No.: 13/066,989

(22) Filed: Apr. 30, 2011

(30) Foreign Application Priority Data
Aug. 23, 2010 (RU) 2010135236/08

(51) Int. Cl. G06Q 50/30; G06Q 10/06

(52) U.S. Cl. 705/345

(57) ABSTRACT

A computer-implemented method for automatically managing the ordering and dispatching of livery car services without a need for a human dispatcher includes operating a central computer server to manage orders initiated by registered livery car service clients and dispatching registered livery car drivers to execute the client orders through an automatic exchange of Internet-based electronic communications comprising predefined electronic message forms or attachments without a need for a human dispatcher. The method also includes registered clients electronically communicating with the central computer server over the Internet to electronically order livery car services by use of a predefined electronic message order form or attachment and registered drivers electronically communicating with the central computer server over the Internet to receive dispatch instructions comprising predefined electronic message forms or attachments relating to the pick-up and delivery of an ordering client. The steps of operating and electronically communicating are executed without a need for human interaction.

### CROSS-REFERENCE TO RELATED APPLICATION

The invention described and claimed hereinbelow claims priority from Russian Patent Application RU , filed on . The Russian Patent Application, whose subject matter is incorporated herein by reference, provides the basis for a claim of priority of invention under 35 U.S.C. 119(a)-(d).

### FIELD OF THE INVENTION

The present invention relates to an automated taxicab services ordering management (AOM) system for automatically managing the ordering and dispatching of livery car services through the Internet, without a human dispatcher.

### BACKGROUND OF THE INVENTION

Modern organization and operation of dispatch centers that provide livery car services, i.e., vehicles for hire, such as taxicabs or chauffeured limousines, typically require a human operator. These dispatch center operators, typically referred to as dispatchers, carry out the reception of orders for taxicab or other livery car services via available telephone communications channels. A person (“client”) in need of a car service, i.e., a ride from a taxi or limousine, will call a taxi or limousine service and place an order verbally to a receptionist or to a dispatcher directly. The dispatcher then determines which cars and/or limousines (“drivers”) are presently available for carrying out the particular order. Typically, the dispatcher and drivers are in two-way radio communication, operating at a particular radio frequency channel. Determining drivers available for a client pick-up hinges not only on available drivers, but the driver's proximity to the client's pick-up location, the drop-off or delivery location, the driver's schedule, etc. This requires that the dispatcher radio any number of drivers to ask for their location and availability, choose one who meets the preferred criteria and assign them to the order.

During other known taxi and limousine management and dispatch operations, communications between drivers and dispatchers can be effected using driver mobile phones, for example, GSM based. In addition, a GPS system might be used to identify the exact location of all car and limousines that might be available for dispatch of a client's order. In a GPS-enabled dispatch system, the car or limousine typically includes a computer-based system for receiving navigation signals (GPS-enabled), a control block (microprocessor or microcontroller-based), memory blocks for storing needed data (for example, application programs, information about a car or limousine, etc.), and a transceiver, i.e., phone for implementing two-way radio transmission and reception of communications with dispatcher. Dispatchers usually operate a computer-based system for transmission and reception of communications with the drivers (i.e., the electronics for in a driver car or limousine), a block of separation of communications, a database, and a display means. Examples of such systems may be found in PCT application publication WO98/11513, Russian Patent Nos. RU 2113013 and RU 2143745. The are problems in maintaining the quality of service with such known livery car dispatching systems, and techniques for operation based thereon, however, as said quality of service at any given time is dependent on the quality of the human dispatchers.

Another known livery car service management system and method for carrying out communications between a central management system and the available cars or limousines that provide client pick-up and delivery is disclosed in PCT publication WO 02103934. The system and method described therein, however, has the same disadvantage of those systems and methods already described, as the quality of service is dependent on the competence of human dispatchers.

Russian Patent No. RU 2253897 describes a system of controlling transportation of passengers in taxicabs. The system includes using GPS satellite communications to monitor the location and therefore availability of taxicabs for particular pick-up locations using a computer of dispatch center. When a client order for a taxicab (pick-up) is received at the dispatch center, the operator inputs information about the client order into a computer via a keyboard. The computer then provides information about several taxicabs (“drivers”) deemed available (by location) to carry out the order, i.e., pick-up and delivery. Based thereon, the operator selects one of the taxicab drivers, and communicates with the taxicab driver via a two-way radio to send him/her the order instructions. If the chosen taxicab and driver is busy, the operator must again review the information, available drivers and their respective locations, using the computer. Once a “next” driver is deemed available, the order or instructions are transmitted to him/her by the operator or dispatcher. The operator then communicates with the client to provide the client with the driver's identification, e.g., taxicab number, and its expected time of arrival.

This patented system, however, has several disadvantages. For one, a dispatch center operation requires a significant number of personnel, which all must be paid salaries. In addition, taxicab drivers frequently are unable to securely maintain in their memory the names of all streets, schematics of in-block passages, streets, roads, and plans of in-block passages of a city or town, so that significant amounts of time are spent for the use of a map and a plan of the city or town. Moreover, transmission of the information through the operator of the dispatch center frequently leads to false information and driving of a taxicab to a wrong place. If this occurs, orders may not be properly implemented and/or multiple communications between the operator, the driver and the ordering party takes place. Either case results in a reduction of the quality of the services rendered.

Such complications also may influence the safety of the traffic. In more detail, for a driver to provide the transportation for the client pursuant to a received order, he/she must access and turn on a speaker phone communication of the radio transmitter to hear the order information and instructions. This typically distracts the driver's attention from the task of controlling the car or limousine, for example, not just be taking the driver's concentration off of the task of driving, but also by obstructing other sound signals that might otherwise warn the driver about some pending danger. Aside from driver distraction, speakerphone communication in a taxicab reduces the quality of service for the passengers (“clients”), where the use of earphone and microphone does not improve the situation.

International Patent No. WO 2006041274 discloses an automated system of ordering and controlling car service, e.g., taxicab operation. The automated system contains means for communicating with an ordering party or client in need of a taxicab services, a central station and a taxicab. The central station includes a computer with means for storing telephone numbers of participants of a communication network with codes of location. The means for storing further includes the GSM telephone numbers of taxicabs that might be able to respond to an order, i.e., an SMS communication. The central station further includes means of reception, counting, registration and storing of SMS communications and phone numbers of GSM taxicabs which transmit them, means for communicating with a GSM telephone (in a taxicab). The means of reception is connected to an interface. The interface is connected to the means for communicating with the ordering party as well as the means for automatically determining a number. The central station means for communicating with the taxicab (GSM telephone) also is connected to the computer. The disadvantage of the aforementioned system is the presence of an intermediate body, a dispatcher, which is similar to the shortcomings of the prior art as described in detail above. Also, data transmission is performed only by means of GSM cell phone communication.

Also known is US Patent Application No. 2009/0030885 (the '885 application). The '885 application is directed to a system for on-demand and scheduled services 100 (SOSS). SOSS system manages payment for services (e.g., credit card payment) rather than managing the taxicab scheduling and routing of customers. The SOSS system 100 includes a user communication interface (UCI) 110, a computer 140, a network 150, an on-demand and scheduled services computer (OS SC) or facilitator 160, a goods/service provider 180 (for example, a credit card services provider) and a service provider (taxicab) 190. The UCIs 110 may be just about any electronic device capable of communication (e.g., smart phone 111, mobile telephone 112, vehicle computer 116, etc.). The UCIs 110 communicate through transceivers 120, 125, 130, 188, 194, with computer 140, service provider 190 and goods/service provider 180. The computer 140 connects to the OSSC 160 through network 150, which OSSC 160 also is connected a plurality of data storages 170.

FIG. 2 shows the OSSC 160 to include a search engine 210, a pricing engine 220, a payment processing engine 230, a documentation engine 240, a cashiering engine 250, a reconciliation engine 260, an account management engine 270, a communication engine 280 configured to manage communication of information within the OSSC 160 and outside the OSSC 160, an inventory tracking engine 285 and an expense management system engine 290. OSSC 160 to identifies and processes financial management services required by a user (UCI 110), such as a taxicab 190 service, booking a flight to another country, reserving a restaurant or hotel, etc.

The goods/service provider 180 (credit card processor service) bidirectionally communicates information with the UCIs 110 (requesters), the computer 140, the OSSC 160 (manager), or the service provider 190 (taxi). The service provider 190 bidirectionally communicates information with the UCIs 110 (requesters), the computer 140, the OSSC 160 (manager), or the goods/service provider 180 (credit card processor). The communicated information includes updates from the service provider 190 such as location information, estimated time of arrival (ETA), traffic conditions, driver name, cab number, etc., which may be helpful post-reservation, but shows no concern about pre-taxicab booking coordination and scheduling.

In an example presented, the goods/service provider 180 (credit card processor service) receives transaction data from the service provider 190 (taxi) regarding a particular transaction (a requestor hails a cab) and the OSSC 160 (manager) processes the transaction data and communicates information associated therewith to the UCI 110 (to the person in the taxi receiving the ride). In more detail, the taxi (service provider 190), which has an electronic card reader, picks up a customer with a UCI 110 who swipes a credit card. The credit card information is communicated from the taxi to the credit card processor as transaction data, e.g., credit card number, time, GPS location, driver name, cab number, closeout data. The data is then communicated by the credit card processor to the OSSC 160, which then communicates the information associated with the transaction data (upon approval) back to the UCI 110.

The system and method of the '885 application, however, does not teach or suggest coordinating or scheduling of a taxicab fleet, or means that are programmed and pre-registered in order to avoid a need for human intervention (i.e., a live dispatcher) to book car service rides. The system and method of the '885 application, therefore, suffers the same quality of service problems as the above-described prior art system and methods

### SUMMARY OF THE INVENTION

The present invention provides a taxicab, limousine or other livery car service automated ordering management (AOM) system, and method for automatically managing the ordering and dispatching of livery cars (i.e., taxis and limousines) using the Internet, which overcome the shortcomings of the prior art

The livery car service automated ordering management (AOM) system, and method for automatically managing the ordering and dispatching of livery car services through the Internet, without a human dispatcher, therefore, eliminates the need for a human dispatcher and, therefore, the human factor connected with it. The AOM system and method also enable car service ordering from any device connected to a worldwide web, i.e., the Internet, by means of operating according to various known communication standards and protocol, e.g., GPRS, EDGE, 3G, WiFi, WiMAX, WAM, LAN, etc.

In one embodiment, a computer implemented application program executes a method of managing the ordering and dispatching of livery car services, i.e., taxicab services, in an automatic ordering management (AOM) system including means for communicating by a client ordering livery car services, preferably in a form of a cellular phone. The client cellular phone communicates with a central station in a form of a computer device (i.e., a central computer server) that includes blocks of processing, storing and input/output. The AOM system also includes means for communicating with livery car drivers, preferably in a form of cellular phones and communication equipment for carrying out communications between client and driver means for communicating, and with the central computer server. The communication equipment, central computer server and the client and driver cellular phones all operate in accordance with the application program to provide the intercommunication required to implement the ordering and dispatching without the need for a human dispatcher.

Use of the AOM system and method results in a reduction of in the time of reaction to the receipt of a new order from a client because the order data is instantaneously supplied to the mobile attachment or driver phones without a dispatcher, i.e., there is no dispatcher. In addition, the use of the Internet enables the AOM system and method to embrace a wider audience of potential clients using only one means of communication, i.e., a cell phone, for example, a GSM-based cell phone.

In another embodiment, a system for automatically managing ordering and dispatching of livery cars to operate a livery car service includes client communication means by which each client registered with the livery car service is able to transmit and receive electronic communications relating to livery car services over the Internet, and livery car driver communication means by which each driver registered with the livery car service is able to transmit and receive electronic communications relating to livery car services over the Internet.

A central computer server programmed to automatically respond to Internet-based electronic communications received from client and livery car driver communication means, including generating and transmitting Internet-based electronic communications to both the client and livery car driver communication means to manage and coordinate the ordering and dispatching of the livery car services. Each client and each livery car driver electronically connects to the central computer sever to register with the livery car service including transmitting specific registration information using respective client and driver communication means.

A subprogram or agent is sent by the central computer server to the respective client and driver communication means upon registration acceptance, which subprogram or agent enables the respective client and driver communication means to transmit and receive required client and required livery driver information from the central computer server in such a way that the ordering and dispatching of livery car services is automatically managed without a need for a human dispatcher.

### BRIEF DESCRIPTION OF THE DRAWINGS

The present invention can best be understood in connection with the accompanying drawings. It is noted that the invention is not limited to the precise embodiments shown in drawings, in which:

FIG. 1 depicts a block diagram representing structure required for operating the livery services automatic ordering management system of the invention;

FIG. 2 is a schematic diagram depicting an embodiment of a processor/server that may be used in the AOM system;

FIG. 3 is a schematic flow diagram depiction an embodiment of a method of automatically managing the ordering and dispatching of taxicab services through the Internet with out the use of a dispatcher, in accordance with the invention; and

FIG. 4 is schematic depiction of a signal-bearing storage media in a form of a magnetic data storage diskette 400 for storing instructions for execution by a processor/server CPU to implement the inventive method.

### DETAILED DESCRIPTION OF THE INVENTION

The following is a detailed description of example embodiments of the invention depicted in the accompanying drawings. The example embodiments are in such detail as to clearly communicate the invention and are designed to make such embodiments obvious to a person of ordinary skill in the art. However, the amount of detail offered is not intended to limit the anticipated variations of embodiments; on the contrary, the intention is to cover all modifications, equivalents, and alternatives falling within the spirit and scope of the present invention, as defined by the appended claims.

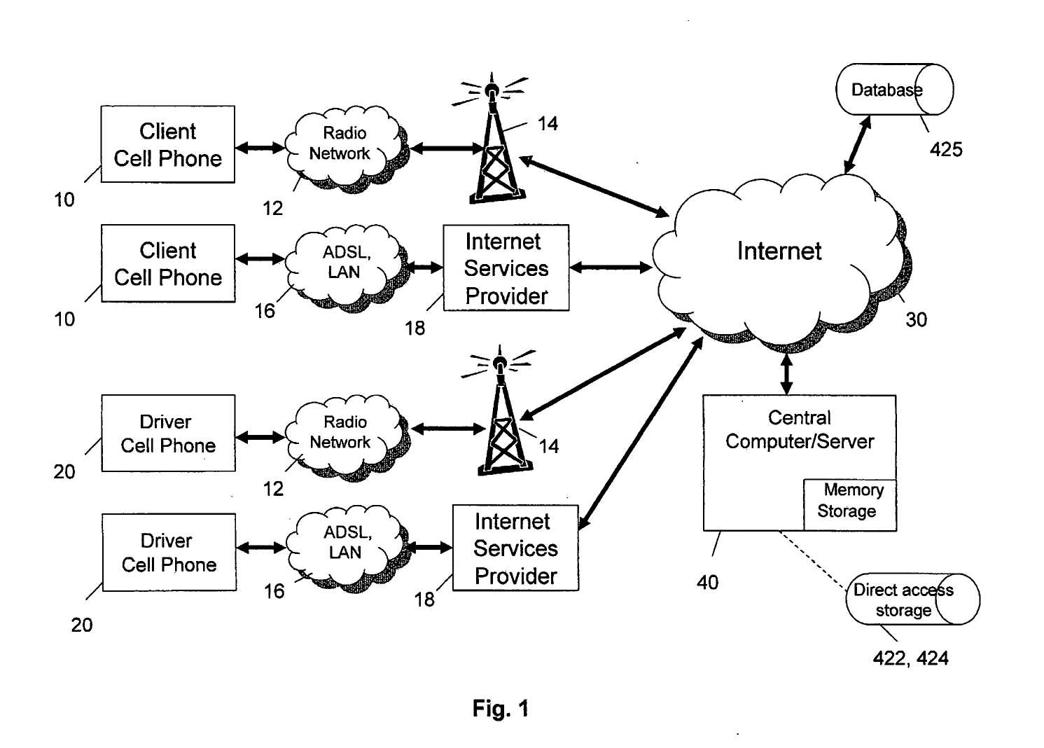

FIG. 1 shows a livery car service automated ordering management (AOM) system for automatically managing the ordering and dispatching of livery car services through the Internet, without a human dispatcher. The AOM system includes client communication means, preferably in a form of a client cell phone 10, for ordering a car service, e.g., taxicab services, etc., and driver communication means, preferably in a form of a cell phone 20, located in a livery car, e.g., a taxicab, for responding to ordering instructions, etc. While both client communication means (e.g., cell phone) 10 and driver communication means (e.g., cell phone) 20 are depicted as cellular telephones, the respective communication means also may comprise a computer or other electronic device, e.g., a Smartphone, a pda, a laptop computer, a notebook computer, an iPhone™, an Android™, a Blackberry™ and a Windows™ Phone 7™, without limitation, configured to any required standard protocol.

Both client communication means (e.g., cell phone) 10 and driver communication means (e.g., cell phone) 20 are enabled to communicate to a computer server 40 at a central dispatch station (central computer server). That is, a client communication means (e.g., cell phone) 10 is shown electronically connected for communicating to a radio network 12, where the radio network 12 is shown electronically connected for communicating with an antenna 14. Antenna 14 may be GPS operational, 3G operational, Wi-Fi operational and WiMAX operational (without limitation), for communicating with Internet 30 and, therefore, central computer server 40. Alternatively, a client communication means (e.g., cell phone) 10 may be electronically connected for communicating to an ADSL or LAN 18, which is electronically connected for communicating with an Internet service provider 18. Internet service provider 18 is electronically connected to the Internet 30 and, therefore, central computer server 40.

Driver communication means (e.g., cell phone) 20 is shown electronically connected for communicating to a radio network 12, where the radio network 12 is shown electronically connected for communicating with an antenna 14. Antenna 14 is GPS operational, 3G operational, Wi-Fi operational and WiMAX operational (without limitation), for communicating with Internet 30 and, therefore, central computer server 40. Alternatively, a driver communication means (e.g., cell phone) 20 may be electronically connected for communicating to an ADSL or LAN 18, which is electronically connected for communicating with an Internet service provider 18. Internet service provider 18 is electronically connected to the Internet 30 and, therefore, central computer server 40.

The central computer server 40 includes functional blocks for data processing, data storing, data input/output and for performing communications with telecommunication network providing connections with the client communication means (e.g., cell phone) 10 and driver communication means (e.g., cell phone) 20. For that matter, the central computer server 40 includes memory storage means, for example, internal memory 416, direct access storage 422 or cloud-based storage 425 for storing and analyzing system data, system operation, client information, driver information, financial information, without limitation.

The client communication means (e.g., cell phone) 10, driver communication means (e.g., cell phone) 20 and the central computer server 40 are configured to operate according to the inventive method. An application program operational in the central computer server 40 automatically manages the ordering and dispatching of taxicab services through the Internet with out the use of a dispatcher (the AOM method), in cooperation with the client communication means (e.g., cell phone) 10, driver communication means (e.g., cell phone) 20 and other system elements and devices. The AOM method provides on-line connection and communication of the elements as shown, maintaining of functions of a control panel and a display 438, 440 necessary for reviewing and editing of the information contained in a memory or database. Each of the client communication means (e.g., cell phone) 10 and driver communication means (e.g., cell phone) 20 includes a program module (in the form of a subprogram or agent of the application program or AOM platform operating in the central computer server 40. The individual subprograms or agents enable the communication means to automatically communicate ordering information, pick-up and delivery instructions, pre-formed messages, etc., directly with the application program operational in the central computer server 40, i.e., to carry out information data exchange, without a need for human interaction.

Using the AOM system according to the inventive method requires that each participating client, before being able to utilize a client communication means (e.g., cell phone) 10 to automatically order a livery car service, e.g., taxicab, and each driver, before being able to utilize a driver communication means (e.g., cell phone) 20 to be automatically notified of possible clients and/or directed to pick-up and deliver particular clients, must first download the program module, subprogram or agent into their respective communication means (e.g., cell phones). The central computer server 40 is provided with the same application program, which enables reception and transmission of data from/to the ordering party (e.g., cell phone), and from/to the car or limousine (e.g., cell phone). Each of the client communication means (e.g., cell phone) 10, driver communication means (e.g., cell phone) 20 and central computer server 40 are managed by the application program in a coordinated mode. The client or ordering party and the car or limousine driver operate the respective client communication means (e.g., cell phone) 10 and driver communication means (e.g., cell phone) 20, while the central computer server 40 operates in the automatic mode without being controlled by the operator, i.e., human dispatcher.

The client or ordering party, via client communication means (the client cell phone) 10 must be registered at the central computer server 40 and introduce his phone number in order to use the system. In order to obtain a car service, e.g. taxicab or limousine, the ordering party inputs information on his communication means (e.g., cell phone) 10 required from him/her by the application program. That is, upon connection during an electronic session, the central computer server 40 presents a data record to the communication means (e.g., cell phone) 10, or some other electronic device, requesting that the client respond by inputting certain required order data in the form of a request for livery car services. This data record containing the required order information may be presented in a verbally synthesized message, in a text screen in an interactive user interface, etc. Examples of the required order information include but are not limited to the client's current location and destination location. The required client order data are sent in a form of an attachment or data record by the cell phone 10 to the central computer server 40 at the central location, by which a copy is stored.

The central computer server 40 then automatically transmits this information (i.e., the client's order data record or attachment) to all of the drivers, i.e., to all of the driver communication means (e.g., cell phones) 20, that also are preregistered. For a car or limousine driver (e.g., cell phone 20) to register to become a system driver, they must register with the central computer server 40. Doing so requires that the driver call and open a session with the central computer server 40 using their respective communication means (e.g., cell phone) 20 or some other electronic device. During the session, the central computer server 40 presents a request for the required driver registration information to the driver's communication means (e.g., the driver cell phone) 20 in a signal or signals forming a verbally synthesized message, forming a text screen in an interactive user interface, etc. The required driver information comprises that information determined by the livery service as a requirement to vet the driver, and may be required to conform to government regulations, e.g., his/her driver's license number, his/her car or limousine licence, his/her vehicle registration, his/her driving record, his/her insurance information, etc. The central computer server 40 then processes the driver information, and stores it, and either allows the driver to become part of the system, or not.

Certain drivers in receipt of the client's order data (attachment or data record) will wish to pick-up and deliver the client, and some will not, for any number of reasons. To be included with those other drivers who wish to be considered for the requested livery service, the driver uses his/her communication means (e.g., cell phone) 20 to send information required for the client to choose the most preferred driver. The information is contained in a data record or attachment and includes details on the driver's car or limousine (car type, color, number, if any, date of arrival formed as a timer of a reverse counting), the driver's estimated cost for the driving services (from pick-up to destination), the estimated time of arrival at the pick-up location, without limitation. The drivers send this information to the central computer server 40 using his/her communication means (e.g., cell phone) 20, whereby the central computer server 40 both stores and sends a copy of each driver's information to the client's communication means (e.g., cell phone) 10.

The ordering client selects from variants proposed to him/her (i.e., the multiple driver data records sent by the central computer server 40), the variant (driver) which is most convenient for him/her. Upon selection, the subprogram or agent in the client communication means 10 sends a confirmation of the selection to the central computer server 40 using his/her communication means (e.g., cell phone) 10. The central computer server 40 sets a counter (not shown), which tracks the waiting time. An order confirmation communication is then sent by the central computer server 40 to both the ordering client communication means (e.g., cell phone) 10 and the selected driver communication means (e.g., cell phone) 20. When the order confirmation communication reaches the ordering party, the information about the expected arrival of the selected taxicab or limousine is displayed on the display of the ordering client's communication means (e.g., cell phone) 10.

If the selected driver does not arrive as scheduled, the ordering client can send a communication in a form of an electronic inquiry to the central computer server 40, which informs the central station that he does not see the selected car and driver. The communication is in a form of a predefined message. The central computer server 40 responds automatically to the predefined message by sending a predefined communication to the communication means (e.g., cell phone) 40 of the selected driver, requesting his/her current location. The driver then responds by sending the required information about his/her current location, and any other relevant information concerning the failure to arrive at the client pick-up location as scheduled.

Several variants are possible after an order is placed including the ordering client selecting a particular car/limousine and driver. For example, the selected car/limousine and driver either reaches the location or an unpredictable even takes place, sometimes referred to as force-majeure. Where a force-majeure event somehow prevents the selected car/limousine and driver from reaching the ordering client's pick-up location as scheduled, the central computer server 40 responds to receipt of a communication reporting same by again transmitting the order (attachment or data record) to waiting list of possible drivers (to their respective communication means 20). Those drivers wishing to be considered for the re-order again must send their particular information from which the client will choose. The central computer server 40, upon receipt of the driver information, stores and sends it to the client, as described above. The client receives all of the available driver information in his/her communication means (e.g., cell phone) 10, and either makes a selection or cancels the order.

If the selected car or limousine and driver arrives at the pick-up location in accordance with a scheduled order, the client may optionally send a confirmation communication to the central computer server 40. Regardless, the driver sends a confirmation from his/her communication means (e.g., cell phone) 20 to the central computer server 40. The confirmation information may take the form of any number of preformed or predefined messages, for example, “I AM AT THE LOCATION”. The driver merely chooses the correct message form (e.g., pick-up confirmation) from any number of predefined or pre-formed messages used by the inventive method, and transmits. All of the form data comprising all of the communications or messages for practising the invention are stored in memory means 422, 424, 425, so that they are readily accessible to the central computer server 40, and therefore, the communication means 10, 20.

After confirming scheduled arrival at the client pick-up location by the selected car or limousine and driver, two variants of events are possible. The ordering client will enter the car or limousine and the driver will deliver him/her to the scheduled destination, or not. If the delivery is completed, the driver utilizes his/her communication means (e.g., cell phone) 20 to send a communication to the central computer server 40 that the scheduled service is completed. For example, this can be done by the driver selecting one of the available predefined messages “CLIENT DELIVERED”. The other identifying information is included in a header of the message, as it comes from the driver's communication means 20, in which the driver agent or subprogram is operational. Alternatively, the ordering client may for some reason not arrive at the selected driver's car or limousine after the driver arrives at the scheduled pick-up location. In this case, the driver will use his/her communication means 20 to send a communication to the central computer server 40 using a pre-defined message form “CLIENT DID NOT APPEAR”.

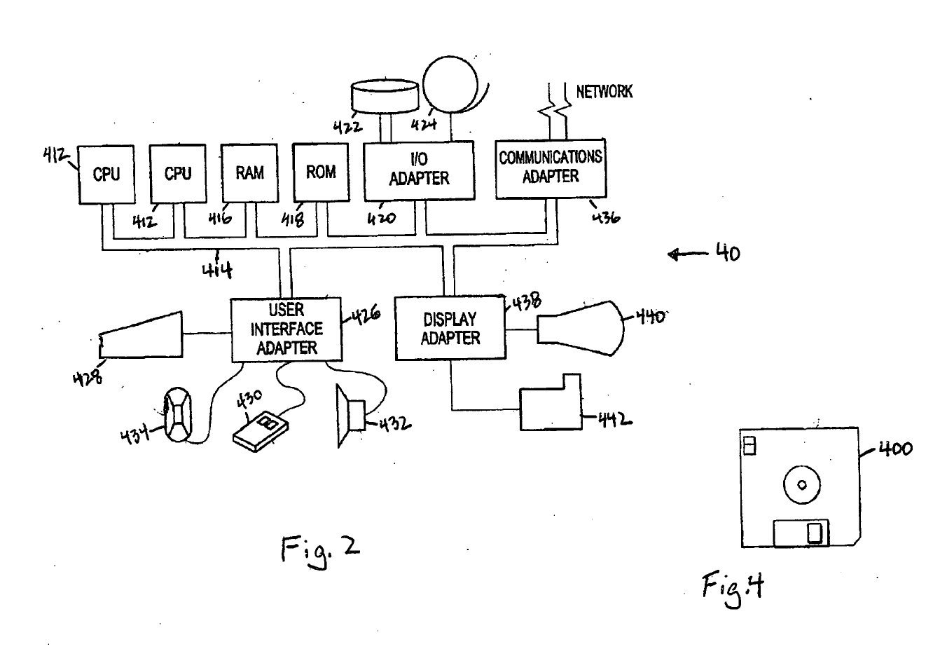

FIG. 2 illustrates a typical hardware configuration of AOM processor/server 40 in accordance with the invention, and which preferably has at least one processor or central processing unit (CPU) 412. CPUs 412 are interconnected via a system bus 414 to a random access memory (RAM) 416, read-only memory (ROM) 418, input/output (I/O) adapter 420 (for connecting peripheral devices such as disk units 422 and tape drives 424 to the bus 414), user interface adapter 426 (for connecting a keyboard 428, mouse 430, speaker 432, microphone 434, and/or other user interface device to the bus 414), a communications adapter 436 for connecting an information handling system to a data processing network (either wireline or wireless), the Internet, an Intranet, a personal area network (PAN), etc., and a display adapter 438 for connecting the bus 414 to a display device 440 and/or printer 442 (e.g., a digital printer or the like).

For that matter, the central computer server 40 may be accessed electronically using any kind of computer device, by authorized user to manage the server, and AOM application program or platform operational therein. The computer device may be connected directly to the central computer server, or indirectly though an intranetwork or the Internet. A subprogram or script is included to operate a web interface to enable attachment to the server and AOM application program, or by a social network.

In addition to the hardware/software environment described above, a different aspect of the invention includes a computer-implemented method for performing the above method. As an example, this method may be implemented in the particular environment discussed above. Such a method may be implemented, for example, by operating a computer, as embodied by a digital data processing apparatus, to execute a sequence of machine-readable instructions. These instructions may reside in various types of signal-bearing storage media.

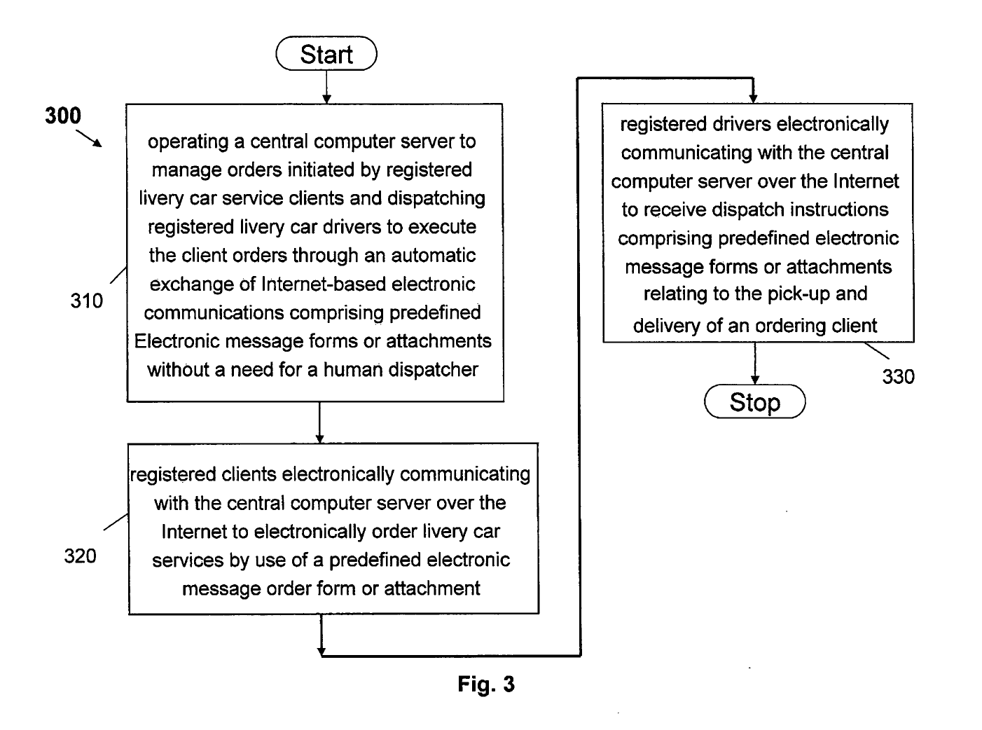

FIG. 3 illustrates an embodiment of a computer-implemented method 300 of automatically managing the ordering and dispatching of livery car services (AOM) through the Internet, without the use of a human dispatcher. Preferably, the interconnecting includes both intra- and Internetwork and the maintaining includes that the database is connected to the processor/server directly, over a network bus such as an Ethernet bus and over the Internet, as shown in FIGS. 1 and 2.

A step of operating a central computer server to manage orders initiated by registered livery car service clients and dispatching registered livery car drivers to execute the client orders through an automatic exchange of Internet-based electronic communications comprising predefined electronic message forms or attachments without a need for a human dispatcher is represented by block 310.

The method also includes registered clients electronically communicating with the central computer server over the Internet to electronically order livery car services by use of a predefined electronic message order form or attachment, represented by block 320, and registered drivers electronically communicating with the central computer server over the Internet to receive dispatch instructions comprising predefined electronic message forms or attachments relating to the pick-up and delivery of an ordering client, represented by block 330. The steps of operating and electronically communicating are executed without a need for human interaction.

Thus, these aspects of the present invention is directed to a programmed product, comprising signal-bearing storage media tangibly embodying a program of machine-readable instructions executable by a digital data processor incorporating the CPU 412 and hardware above, to perform the AOM method of the invention.

This signal-bearing storage media may include, for example, a RAM contained within the CPU 412, as represented by the fast-access storage for example. Alternatively, the instructions may be contained in another signal-bearing storage media, such as a magnetic data storage diskette 400 (FIG. 4), directly or indirectly accessible by the CPU 412.

Whether contained in the diskette 400, or some other computer readable medium, the processor/server 40 comprising CPU 412, or elsewhere, the instructions may be stored on a variety of machine-readable data storage media, such as DASD storage (e.g., a conventional “hard drive” or a RAID array), magnetic tape, electronic read-only memory (e.g., ROM, EPROM, or EEPROM), an optical storage device (e.g. CD-ROM, WORM, DVD, digital optical tape). Other suitable signal-bearing media include memory devices in transmission media and instructions stored in formats such as digital and analog and memory devices in communication links and wireless. In an illustrative embodiment of the invention, the machine-readable instructions may comprise software object code. It should also be obvious to one of ordinary skill in the art that the technique of the present invention could be implemented on a network in a variety of configurations.

Hence, the invention includes a computer program product including a processor and a set of processor readable instructions that when executed by the processor execute a method of automatically managing the ordering and dispatching of livery car services (AOM) through the Internet with out the use of a human dispatcher.

In the foregoing description, certain terms and visual depictions are used to illustrate the preferred embodiment. However, no unnecessary limitations are to be construed by the terms used or illustrations depicted, beyond what is shown in the prior art, since the terms and illustrations are exemplary only, and are not meant to limit the scope of the present invention.

It is further known that other modifications may be made to the present invention, without departing the scope of the invention, as noted in the appended Claims.

What is claimed is:

1. A system for automatically managing ordering and dispatching of livery cars to operate a livery car service, comprising:
client communication means by which each client registered with the livery car service is able to transmit and receive electronic communications relating to livery car services over the Internet;
livery car driver communication means by which each driver registered with the livery car service is able to transmit and receive electronic communications relating to livery car services over the Internet;
a central computer server programmed to automatically respond to Internet-based electronic communications received from client and livery car driver communication means, including generating and transmitting Internet-based electronic communications to both the client and livery car driver communication means to manage and coordinate the ordering and dispatching of the livery car services;
wherein each client and each livery car driver electronically connects to the central computer sever to register with the livery car service including transmitting specific registration information using respective client and driver communication means, and wherein a subprogram or agent is sent by the central computer server to the respective client and driver communication means upon registration acceptance, which subprogram or agent enables the respective client and driver communication means to transmit and receive required client and required livery driver information from the central computer server in such a way that the ordering and dispatching of livery car services is automatically managed without a need for a human dispatcher.

2. The system of claim 1, wherein the central computer server electronically stores predefined electronic form messages configured for presentation to client and driver communication means, with which predefined electronic form messages the clients and drivers interact by inputting any required information necessary for registration and ordering and dispatching of livery car services.

3. The system of claim 1, wherein the subprogram or agent active in each client and driver communication means operates an interactive user interface for delivering and receiving required information for the ordering and dispatching of the livery services

4. The system of claim 2, wherein the predefined electronic form messages are stored in any of the group consisting of a memory in the central computer server, a memory accessible to the central computer server, a database accessible to the central computer server, the client communication means and the driver communication means.

5. The system of claim 1, wherein the client and driver communication means comprise any of the group consisting of a Smartphone, a pda, a laptop computer, a notebook computer, an iPhone™, an Android™, a Blackberry™ and a Windows™ Phone 7™.

6. The system of claim 1, wherein the client and driver communication means electronically connect to the Internet, and thereby the central computer server using a radio network or an asymmetric digital subscriber line (ADSL), using any known standard communication protocol or standard.

7. The system of claim 6 wherein communication protocol or standard comprises any of the group consisting of GPS, EDGE, 3G, WiFi, WiMAX, WAN, LAN.

8. A computer-implemented method for automatically managing the ordering and dispatching of livery car services without a need for a human dispatcher, comprising:
operating a central computer server to manage orders initiated by registered livery car service clients and dispatching registered livery car drivers to execute the client orders through an automatic exchange of Internet-based electronic communications comprising predefined electronic message forms or attachments without a need for a human dispatcher;
a registered client electronically communicating with the central computer server over the Internet to electronically order livery car services by use of a predefined electronic message order form or attachment;
a registered driver electronically communicating with the central computer server over the Internet to receive dispatch instructions comprising predefined electronic message forms or attachments relating to the pick-up and delivery of an ordering client;
wherein the steps of operating and electronically communicating are executed without a need for human interaction.

9. The method of claim 8, wherein the step of operating further includes maintaining a store of predefined electronic message forms or attachments comprising predefined data fields and predefined messages for use in the steps of electronically communicating between registered clients and registered drivers, between registered clients and the central computer server and between the registered drivers and the central computer server.

10. The method of claim 8, wherein the step of operating further includes establishing a session with registering clients and registering drivers during which client and driver information is captured in specific predefined electronic message forms, electronically communicated to, processed and stored by the central computer server, and a subprogram or agent is downloaded to communications means of the respective registered clients and drivers.

11. The method of claim 10, wherein the subprogram or agent operates a user interface at the respective client and driver communication means to present the predefined electronic message forms and to enable electronic communication with the central computer server without need of a human dispatcher.

12. The method of claim 9, wherein the predefined electronic message forms are stored in any of the group consisting of a memory in the central computer server, a memory accessible to the central computer server, a database accessible to the central computer server, the client communication means and the driver communication means.

13. The method of claim 11, wherein the client and driver communication means comprise any of the group consisting of a Smartphone, a pda, a laptop computer, a notebook computer, an iPhone™, an Android™, a Blackberry™ and a Windows™ Phone 7™.

14. The method of claim 11, wherein the client and driver communication means electronically connect to the Internet, and thereby the central computer server using a radio network or an asymmetric digital subscriber line (ADSL), using any known standard communication protocol or standard.

15. The method of claim 14, wherein communication protocol or standard comprises any of the group consisting of GPS, EDGE, 3G, WiFi, WiMAX, WAN, LAN.

16. The method of claim 8, wherein the ordering by the registered client includes inserting required ordering information in a predefined electronic message order form and transmitting the predefined electronic message order form to the central computer server.

17. The method of claim 16, wherein the central computer server responds to the receipt of the predefined electronic message order form automatically by generating and communicating a predefined electronic message form comprising the ordering information to registered driver communication means.

18. The method as set forth in claim 17, wherein the registered drivers respond to receipt of the ordering information by forwarding a predefined electronic message form comprising at least their location and availability to respond to the central computer server.

19. The method as set forth in claim 18, wherein upon receipt and processing of the location and availability information from responding livery drivers, the central computer servers sends a predefined electronic message form including information about available drivers to the ordering client.

20. The method as set forth in claim 19, wherein upon receipt of the predefined electronic message form including information about available drivers, the ordering client selects a driver and sends a predefined electronic message form including the driver selection information to the central computer server, in response to which a predefined electronic message form confirming the driver's selection is communicated to the driver's communication means.

21. A system comprising a computer with a microprocessor programmed with a set of computer readable instructions that upon execution by the microprocessor functions as a server and operates in accordance with the method of automatically managing the ordering and dispatching of livery car services without a need for a human dispatcher, as set forth in claim 8.

22. A computer program product including a processor and a set of processor readable instructions that when executed by the processor execute a method for automatically managing the ordering and dispatching of livery car services without a need for a human dispatcher, as set forth in claim 8.
